(19) United States
(12) Patent Application Publication
(10) Pub. No.: US 2006/0053021 A1
(43) Pub. Date: Mar. 9, 2006

(54) Method for monitoring and managing an information system

(76) Inventor: Ingemar Bystedt, Bromma (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/522,357

(22) PCT Filed: Aug. 7, 2003
(86) PCT No.: PCT/SE03/01264

§ 371 Date: Jan. 26, 2005

Related U.S. Application Data
(60) Provisional application No. 60/319,469, filed on Aug. 14, 2002.

(51) Int. Cl. G06Q 99/00

(52) U.S. Cl. 705/1

(57) ABSTRACT

The method of monitoring an information system and has a real-time engine unit in communication with a broker unit. The engine unit has an event source unit and a metrics source unit and receives an event signal from the source unit in a first protocol language. The engine unit obtains a metrics parameter in a signal from the source unit in a second protocol language. The engine unit receiving the information in the first and second protocol languages and converts the signals to a third protocol language that is transmitted in a signal in the third protocol language to the broker that, in turn, converts the information to a universal protocol language that is understood by a plurality of consumers units.

### BACKGROUND OF INVENTION

Today many information technology (IT) environments are becoming more heterogeneous so that a mixture of software products and hardware platforms is used in many IT business systems. Very often this mixture of components makes it more difficult to survey and keep track of the performance of the components so that a number of consoles with different management systems must be used. This makes it also difficult to manage and to effectively monitor the components of the entire management system. The many protocols and languages used in the communication between the heterogeneous components make it cumbersome and sometimes impossible for one component to communicate with another component of the information system. There is a need for a reliable and effective way of monitoring and managing heterogeneous components in IT management systems. Furthermore, it is a great risk of introducing management and monitoring since there are a lot of tasks that need to be successfully completed such as deployment and configuration of each machine before you get the return of the investment.

### SUMMARY OF INVENTION

The system of the present invention provides a solution to the above-outlined problems. The components are, preferably, built on standard components and have an open interface to easily be able to integrate new components, such as source/providers and consumers, into the system. The system does not consume any extensive amount of resources such as computer processor unit memory or network traffic. There is no need for polling of log files, execution of interpreted code or image activation to keep the resource consumption at a low level. More particularly, the method of the present invention is for monitoring an information system and has a real-time engine unit in communication with a broker unit. The engine unit has an event source unit and a metrics source unit and receives an event signal from the source unit in a first protocol language. The engine unit obtains a metrics parameter in a signal from the source unit in a second protocol language. The engine unit receives the information in the first and second protocol language and converts the signals to a third protocol language that is transmitted in a signal to the broker 14 that, in turn, converts the information in the third protocol language to a universal protocol language that is understood by a plurality of consumers units.

The real-time engine has an algorithm to write rules that may be executed when an event in the rule is triggered. Employing a real-time engine may be done by installing the software which by an built-in procedure configures itself to recognize all event and metric sources that are to be monitored. During the deployment, the installation procedure will find out the language used on the machine and if known by the engine the localized version will be used. The localization is done without having to expose source code but only to generate files that are used for the other language.

### BRIEF DESCRIPTION OF DRAWING

FIG. 1 is a schematic view of certain components of the system of the present invention;

FIG. 2 is a schematic view of the interaction between source units and the engine unit of the system of the present invention; and

FIG. 3 is a schematic view of several application services connected to the engine unit of the present invention.

### DETAILED DESCRIPTION

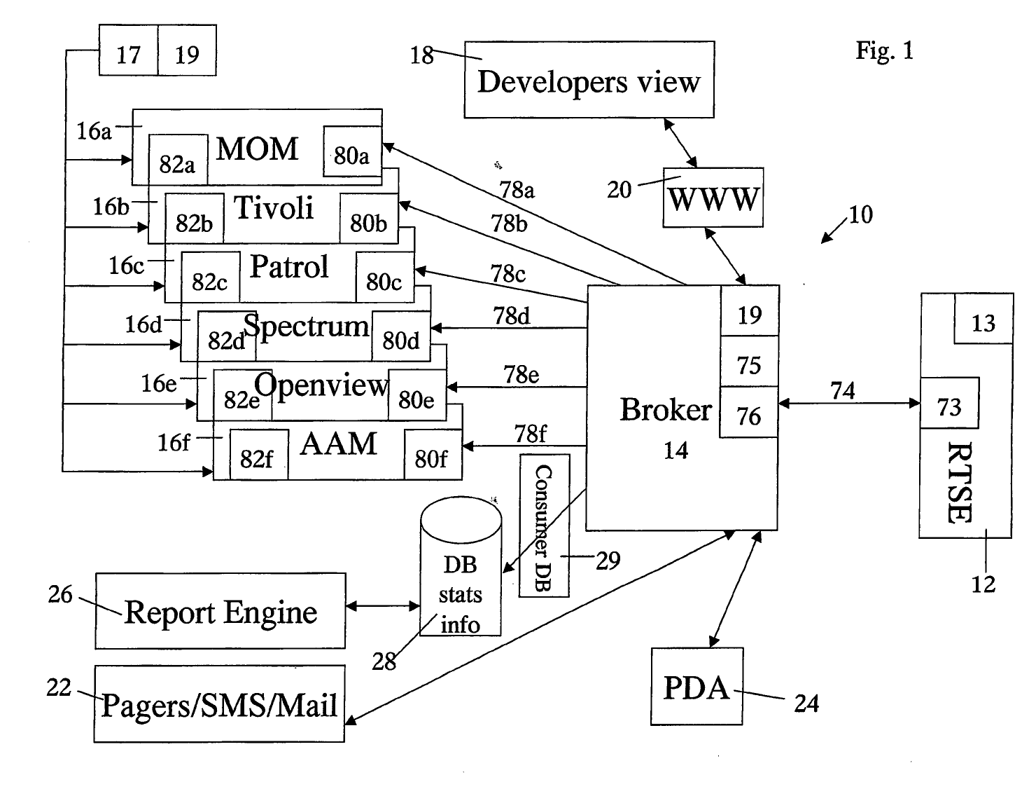

With reference to FIG. 1, the information system 10 has a real time surveillance engine (RTSE) 12 in communication with a broker unit 14 such as a management information broker that, among other things, handles and distributes management and system status information that are received by the engine 12 from various source providers. The engine 12 may also perform basic filtering, consolidation and correlation of events including aggregation of information to minimize the amount of information that is sent within the system 10. The engine 12 may be a production computer, such as a server that functions as a provider that gathers information from source providers in the system 10. The engine 12 may monitor the system through a shared memory 13.

In general, the unit 14 is often in communication with a plurality of engines 12 and the information received therefrom is disseminated or distributed to a set of consumers 16. The communication between the engine 12 and the broker 14 may be based on ordinary TCT/IP protocols to enable the communication to run on a secure connection such as IPSEC. The communication protocol/language used between the engine 12 and the broker unit 14 may be unique so that the engine 12 can only communicate with the broker unit 14 and that the protocol or language cannot be understood by any other component of the system 10. The broker unit 14 may be a proxy broker that makes it possible to switch the direction of the communication to pass firewalls without having to open a number of ports that can be security holes.

As indicated above, the unit 14 also interacts with a set of consumers 16a-16f that in turn may be in contact with a user 17 or several users having a console 19. The consumers 16 may, through an open connection with the broker unit 14, receive information and may, for example, present the information on a console 19 for a user 17, store the information in a data, and integrate it into a management framework. The consumers may be standard monitoring units such as Microsoft Operations Managers (MOM) 16a, Tivoli 16b, Patrol 16c, Spectrum 16d, Openview 16e and AAM 16f and other monitoring systems. For example, the MOM 16a is only usable with a Microsoft operating system. As is explained in detail below, if it is necessary to monitor systems that are not compatible with MOM 16a, the engine 12 may be used to monitor such other information system. For example, the engine 12 may be used to extend the ability of MOM 16a to monitor Unix operative systems.

The information obtained by the engine 12 is sent to the broker 14 that converts the information to a language or format that can be read and understood by all the consumers 16a-16f. The user 17 may therefore use the MOM source unit 16a to obtain information via the broker 14, the engine 12 and the sources 30-40. An important feature is that the user 17 would normally not be able to obtain this information had not the consumer unit 16a been in communication with the broker 14 and the service provided by the engine 12.

Prior to sending the information to the broker 14, the engine 12 may convert the obtained information into a format/protocol that can be read by the broker and the broker converts the information received from the engine into a format that can be read by all the consumers 16a-16f. Because the information from the engine 12 to the broker 14 is standardized to the unique protocol, the broker 14 cannot determine from where the engine 12 obtained the information sent to the broker 14. Because the broker 14 does not know where the information is coming from, it is not necessary to include special codes in the information message from the engine 12 to the broker 14 to enable the receiving broker 14 to handle the incoming information. As outlined below, it is, in this way, possible to extend the use to the various standardized consumers 16a-16f to handle and receive information that the consumers would not normally be able to handle.

More particularly, the broker 14 has the capability of communicating with the engine 12 by using a unique communication language/protocol 73 that is only used in communication between the engine 12 and the broker 14. The protocol 73 may be such that none of the consumers 16a-16f can handle the protocol/language 73. The broker 14 receives an information signal 74, in the protocol 73, from the engine 12. The information signal 74 includes information that the engine 12 has received or obtained from one or many of the source units 30-40. A conversion unit 75 of the broker 14 converts the information in the signal 74 to a uniform protocol 76 that is understood by all the consumers 16a-16f. The broker 14 forwards an information signal 78a, in the uniform protocol 76, to, for example, a MOM consumer unit 80a that is part of the MOM unit 16a. The unit 80a receives the information signal 78a and converts the information from the universal protocol 76 to a MOM protocol 82a that is used by the MOM unit 16a. Similarly, the broker 14 may send information signals 78b-78f to the consumer units 80b-80f, respectively and each unit 80b-80f converts the received information to the Tivoli protocol 82b, Patrol protocol 82c, Spectrum protocol 82d, Openview protocol 82e and AMM protocol 82f, respectively.

A developer unit 18 is in communication, via the Internet 20, with a developer conversion unit 19 of the broker unit 14. The developer may in this way use a protocol that is suitable to the developer although the consumers 16a-16f and the engine 12 use different languages and protocols. Other components of the system 10 include communication devices 22, 24 used by the consumers 16a-16f and a report engine 26. The report engine 26 is in communication with a database unit 28 that in turn is in communication with the broker unit 14. The engine 26 may be used to retrieve charts to interpret the data and to develop prognoses. There may be a consumer database 29 disposed between the database 28 and the broker 14 for storing information over time to better be able to determine, for example, when the servers of the system are going to become too small as the response times are increasing. The historical data in the database 29 may be used for prognoses.

As indicated above, an important feature of the present invention is that the consumer unit 16a-16f may have access to service providers that are normally not included with the consumer units and normally cannot efficiently communicate with the consumer units. As explained below, another important feature is that it is possible to link metric parameters and events so that a series of commands may be carried out automatically.

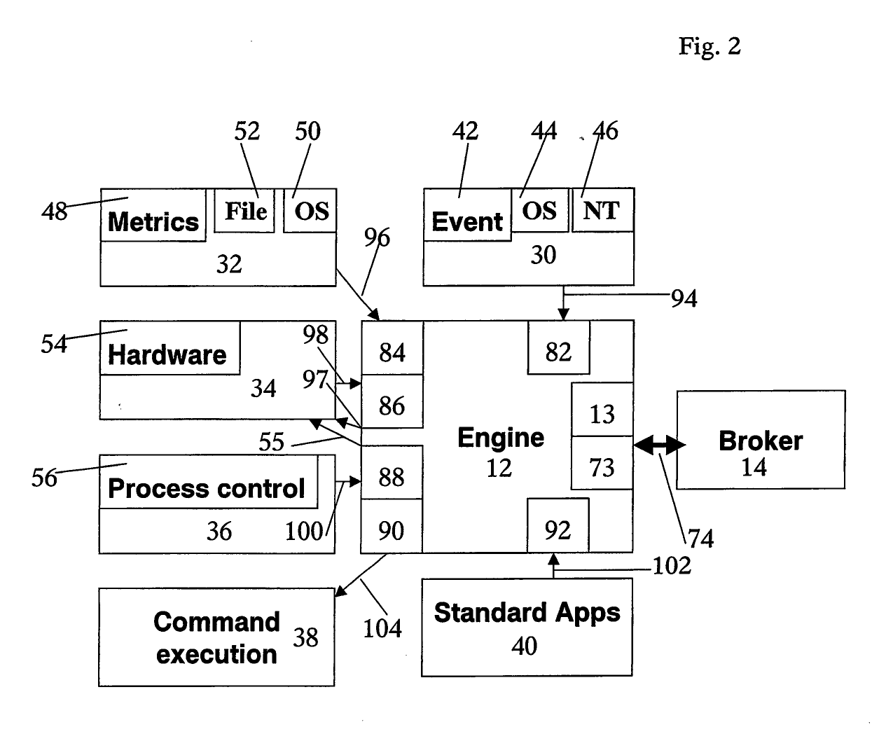

FIG. 2 shows a more detailed view of the engine 12 in combination with information source units 30, 32, 34, 36, 38 and 40. More particularly, the unit 30 may be used to monitor events 42 such as the system log of an operating system 44 or event log of an NT system 46. Unlike metric parameters, events 42 normally do not have to be retrieved. The engine 12 may subscribe to all events and no source is polled since the polling procedure may cause problems. The event messages 42 normally include the source of its origin, the identity such as a number or an abbreviation, severity status and text that explains the event. When the engine 12 recognizes a new event, the engine assigns the event a new identity.

The following field segments may exist when defining the event 42 including a description field of the event that may be used by one of the consumers 16, a severity field that may range from a none status if the event does not create an event to a discard status if the event should be filtered away. The event could also be fatal. The information field may also include a counter when the event is to be associated with a metric parameter so that the number of events is counted until a threshold value is reached. For example, when three events have been counted a disk failure signal may be sent to the user to alert the user to swap the disk to avoid a total disk crash. The field may also include an escalation field to be able to raise the severity level of the event to put more attention on the problem event. Another field may be an affect field that may be used to notify the user that the event may affect another event such as notifying the user that a process is not having any problems when a successful startup event is received. This is a form of auto-acknowledgement of an event to let a program declare itself as being in good condition. The field segment may also include a dependent field that checks if other events are in a predefined severity and this basic information may be used to do event aggregation. Finally, the field segment may include an action field to show which action should be taken when an event has occurred. This makes it possible to perform automatic actions without the information having to leave the node of the network such as restarting the process. When the required information is spread over several nodes, such aggregation preferably takes place in one of the consumers 16 to the broker 14.

It is possible for an event to issue or trigger another event. The consumer may manually acknowledge an event. Two types of acknowledgements may be used such as an accept response that means the event has been recognized and will be fixed and a close response that means the problem has been solved.

The events 42 could be any message such as information through SNMP traps that may relate to such things as when the reading or printing process has failed. The operation system 44 may be event triggered so that no message is sent to the engine 12 until an event has occurred. This saves on the computer resources because there is no need for the engine 12 to intermittently monitor the status of the source 30. A variety of sources could be used to feed the events unit 32 such as Windows Event Viewer, SNMP traps, processes, including services on Windows and information whether the process is running or not, ports to see if the port is open and use, IP addresses to see if it is possible to connect to a particular IP address and console ports to retrieve system messages and also to access the system.

The unit 32 may be used to monitor metric parameters 48 such as parameters from an operating system 50 through API and files 52. The metric parameters 48 are a very important tool, not only to find broken thresholds to indicate a malfunction, but also to collect information to be able to predict course of events such as capacity planning, measure quality of service or to deal with statistics. This means that some parameters have events associated with a breach of a threshold. Other parameters may feed their values into a service level management system to keep track of breaches to a service level. The parameters 48 may be used as an intelligent monitoring tool. For example, if the queue length is measured from the Internet gateway, the parameter may be used to put a threshold in the derivate so it is growing very quickly. This growth may indicate that there may be a storm of incoming mail. If it grows continuously, it can imply that there is some problem with the processing of incoming mails If it is very often high, the derivate may indicate a capacity problem. The metrics parameters may also be used to feed values into graphs that, for example, show the correction between TV commercials and a hit rate on a web page on the Internet.

It may also be possible to derive a metric parameter from another metric parameter and put a maximum value on one of the metric parameters so that the user is notified if the maximum value is reached too often. When the collection of the historical maximum values is of interest, it is not necessary to associate the maximum value with the new metric parameter. The metric parameters may be characterized into two severity categories such as warning and error. In general, only events can be fatal. The metric parameters may be measured in at least three different ways such as the minimum, maximum and the derivate to control growth or depreciation. Of course, other thresholds may be defined and used.

As outlined below, one of the consumers 16 may access and read metric parameters via the broker 14 by sending a command to the broker 14 so that the broker stores the metric parameter value received from the engine 12 in a database or displays the metric parameters in real-time graphics. It may also be possible to predetermine how often a metric parameter is checked so that important metric sources are checked more frequently than less important or expensive metric sources. The system 10 could also be set up so that the consumer is in contact with a plurality of engines to be able to compare the metrics from different engine servers to carry out an application-centric load balancing.

The parameters 48 may also relate to speed of the CPU, the number of network I/O per time unit, the number of read tasks completed on the disc and other such measurable parameters. A variety of sources could be used to feed the metrics unit 32 such as Windows Performance Monitor, MIB, SNMP Management Information Base, files including directories, system parameters in files, system service calls to retrieve basic metrics information for the operation system including computer process unit and memory data.

The unit 34 may be used to monitor and identify hardware errors 54 through SNMP, API and other protocols. The errors 54 are usually event related such as a reading error on the disc. The errors 54 are simply a different source compared to the more general events from OS system log 44 and NT event log 46, as shown in source 30. The hardware errors 54 are important enough for the engine 12 to actively send status request signal 55 to the unit 34 to make sure there are no unreported errors in the hardware monitored by the unit 34.

The unit 36 is adapted for a process control 56, such as an email function or any other function or process, through an application programmer interface (API) protocol to check on certain aspects of the operating system.

As indicated above, the events of the source units 32, 34, 36 may have a higher priority than the general event 42 in that the engine 12 more actively monitors the events of the units 32, 34, 36 instead of waiting for the event to occur which is common when learning about events in the source unit 30. It is sometimes necessary for the engine 12 to more actively monitor the units 32, 34, 36 because no error message may be sent to the engine 12 when a function/process in one of the units goes down.

The unit 38 may execute commands as a result of, for example, events 42 and other triggering factors. For example, when the engine 12 receives an event that may relate to the failure of a database then the engine 12 sends an activation signal to the execution unit 38 to carry out a command to repair the database or the disk. The unit 38 may also be time driven so that it automatically carries out tasks, such as the maintenance or monitoring of a disc, during certain time frames such as 3 a.m. at night.

The unit 40 is mainly used for standard applications such as running more than one application on one computer. However, there may be no automatic event reporting from the unit 40 to the engine 12 so the engine 12 must monitor the unit 40 for any application error through API. It is to be understood that the engine 12 may carry out and simultaneously communicate with several or all of the units 30-40.

An important feature of the engine 12 and the various source units 30-40 is that although many different types of information is obtained by the engine 12, the report signal 74 from the engine 12 to the broker 14 is always in the same predetermined form, such as in the language/protocol 73. More particularly, the engine 12 has a plurality of conversion units 82, 84, 86, 88, 90, 92 for communicating with the source units 30-40, respectively. A general event signal 94 may be received by the unit 82 and converted to the language/protocol 73 before it is sent in the information signal 74 to the broker unit 14. Similarly, a parameter signal 96 from the source unit 32 is received by the unit 84 and converted to the protocol 73. In response to a request signal 97 from the engine 12, the unit 34 may send a hardware error signal 98 to the unit 86 that converts the information to the protocol 73. The source units 34, 36, 40 send signals 98, 100, 102, respectively that are all converted to the protocol 73. The unit 90 may send a special signal 104 to the unit 38, as outlined above.

The fact that many different sources are monitored improves the accuracy and reliability of the engine 12 compared to relying on only one source. The engine 12 of the present invention is not limited to sequential analysis of the source units 30-40. The use of the special reporting protocol 73 to the broker 14 regardless of the protocol used in the incoming signals 94, 96, 98, 100, 102 makes it easier for the broker 14 to handle such incoming information signal 74 because no extra coding is required by the broker 14.

It is possible to connect the metric parameters 48 with the events 42. If, for example, the response time for a parameter 48 exceeds a certain time period an event 42 may be triggered. It is also possible to do the opposite i.e. connect events to a parameter. If, for example, five password error events have been triggered within a certain time period, the number of events may be counted by the parameter 48 and the parameter may be used to report such value to the engine 12 when a threshold value has been exceeded. In this way, the events generate a report from the parameter to the engine.

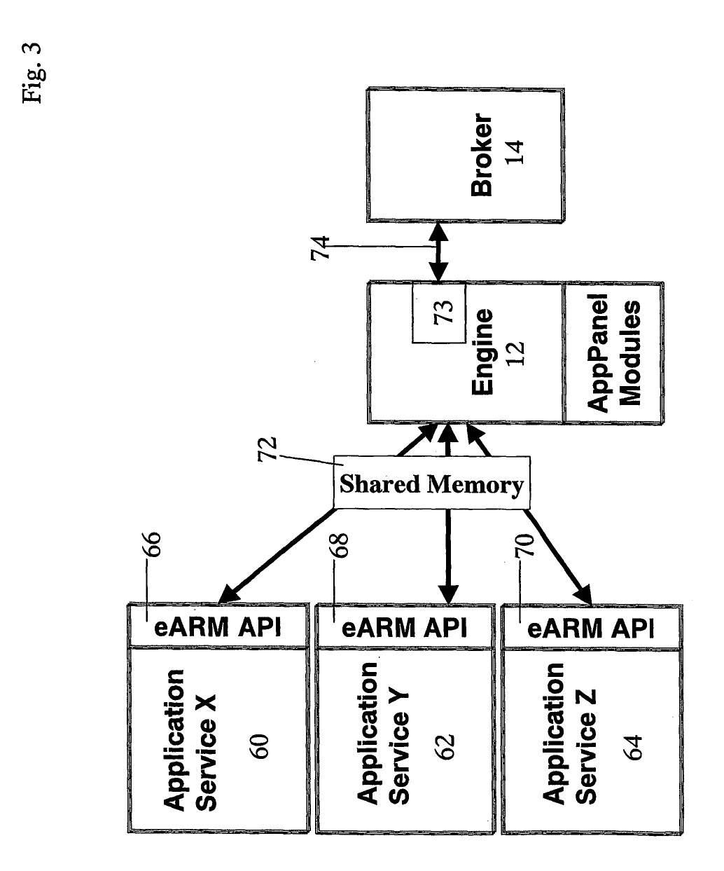

FIG. 3 shows the engine 12 in communication with three applications services 60, 62, 64, such as banking applications, that each has extended Application Response Measurement (eARM) units 66, 68, 70, respectively, for library functions. ARM (Application Response Measurement) is a standard that is currently available from software suppliers. The eARM is mainly based on ARM but it is an extension to the ARM API but fully contains the capabilities of ARM. The eARM unit may not only be used for measuring transaction times but also as a source to the engine 12 to add on functionality beyond the handling of metric parameters and events. The engine 12 checks that all transactions are completed. Not only the duration of transactions is important but also when a transaction was never completed. This means that an ASP or JSP web page could be supervised so that the user will not get the undesirable conduct that the server does not respond. ARM has the capability of keeping information along with the transaction that may be automatically kept by the engine 12 as the context of the transaction. This information may be automatically logged to keep an automatic audit log for the application.

For example, the service 60 may relate to transferring money from one bank account to another bank account within the same bank. The service 62 may relate to transferring money from one bank to another bank and the service 64 may relate to receiving money from another bank. Of course, the services may relate to any suitable service. The eARM units 66, 68, 70 may be used to monitor such money transfers and how long such transfers take to help the developer measure how long certain activities take. If the transfers take longer than they should, the engine 12 may send an error signal to the broker 14. There may be a shared memory 72 disposed between the eARM units and the engine 12. The memory 72 may be used as a buffer between the monitoring function of the engine 12 and the applications 60, 62, 64.

When a new source is added to the engine 12, there is no need to modify the broker unit 14 or any of the consumer units 16a-16f because the information obtained from the new source will be presented in the same protocol 73 from the engine 12 to the broker 14.

The rule engine is a part of the real-time engine and can execute relations written in XML, to filter, consolidate and aggregate events and perform an action based on the information. The rule engine may only act on events and therefore a threshold on a parameter may activate an event if such a breech is detected. The algorithm may be designed so that only the affected events of the event that is affected by the breech of the threshold need to be evaluated. No polling or other resource consuming execution needs to take place.

The parameters Param 1 and 5 have a connection which may be described by the XML code as:

| | |
|---|---|
| : | |
| <parameters> | |
| : | |
| <parameter | identity=‘Param1’ |
| | descriptor=‘the first of two params to watch’> |
| <source | oid=‘1.3.6.1.2.1.1.3.0’/> |
| <rules | error_max=‘70,0,0,0,0,Event2’ |
| | warning_max=‘50,0,0,0,0,Event2’/> |
| <options | disable=‘no’ |
| | history=‘yes’ |
| | display=‘yes’/> |
| </parameter> | |
| : | |
| <parameter | identity=‘Param5’ |
| | descriptor=‘the last of two params to watch’> |
| <source | metric=‘UnusedSlots’/> |
| <rules | error_min=‘5,0,0,0,0,Event4’ |
| | warning_min=‘20,0,0,0,0,Event4’/> |
| <options | disable=‘no’ |
| | history=‘yes’ |
| | display=‘yes’/> |
| </parameter> | |
| : | |
| </parameters> | |
| <events> | |
| : | |
| <event | identity=‘Event2’ |
| | descriptor=‘Threshold on Param1’> |
| <options | discard=‘yes’/> |
| <rules | affect=‘Event3’/> |
| </event> | |
| <event | identity=‘Event3’ |
| | descriptor=‘Health of Param 1&5’> |
| <rules | dependent=‘Event2,Event4’/> |
| </event> | |
| <event | identity=‘Event4’ |
| | descriptor=‘Threshold on Param5’> |
| <options | discard=‘yes’/> |
| <rules | affect=‘Event3’/> |
| </event> | |
| : | |
| </events> | |
| : | |

The parameters Param 1 and 5 may signal for Event 2 and 4 respectively when the defined threshold is breached. This is executed and calculated by the function for threshold checking when these values have been delivered from its source. If the Parameter 1 breaches its threshold, Event 2 will be signaled to the Rule Engine. The Rule Engine will see that this affects only Event 3 so the Rule Engine does a recursive call to itself using Event 3. Evaluating the rule of Event 3 makes that we will check status of Event 2, which was just set, and Event 4. The highest state from Information, Warning, Error och Fatal may be set and then signaled to the broker and further disseminated to the rest of the connected consumers.

Of course, the events can be a mixture of any parameter or event to make up the rules. The most important function to make it easy to evaluate is that all states are stored as events and linked together so that we never have to evaluate more events than can affect the resulting event.

The time to deploy monitoring and management is a very important issue since many project fails as early as in this phase. The deployment of the real-time engine is therefore made fully automatically so that the user does not have to or is permitted to interfere in the installation phase. To let the real-time engine be as small as possible, the total functionality is divided between two executables, the real-time engine and a utility program that performs functions that it not necessary to do all the time but rather seldom. The most important functionality is to recognize all applications including the operating system and the hardware that the real-time engine has a predefined schema how to monitor. This recognition is described in yet another schema that includes directive to recognize files, directories, running services or processes, registry variables and other entities in the environment which permits the determination if an application is running on this computer. The Utility program reads the Recog file and creates the Private file. This file contains references to all products, e.g. Microsoft Exchange 2000 (E2K) running on a Microsoft Windows 2000 Server (W2K) but no SQLserver 2000 (SQL2K) was found.

A part of the Recog file concerning Microsoft SQL may look like:

<product identity=‘SQL’ amm=‘msSQL70’

path=‘HKEY_LOCAL_MACHINE’
key=‘Software\Microsoft\Microsoft SQL Server 7.0’>

```
    <file name=‘epm_MSsql70’/>
    <file name=‘epm_mssql70db_info’
```

object=‘SQLServer:Databases’
counter=‘Active Transactions’
instance=‘*’/>

</product>
<product identity=‘SQL’ amm=‘msSQL65’

path=‘HKEY_LOCAL_MACHINE’
key=‘Software\Microsoft\MSSQLSERVER\...’
variable=‘CurrentVersion’
value=‘6.5’>

```
    <file name=‘epm_mssql65’/>
    <file name=‘epm_mssql65_log’
```

object=‘SQLServer-Log’
counter=‘Log Space Used(%)’
instance=‘*’/>

<file name=‘epm_mssql65_users’

object=‘SQLServer-Users’
counter=‘CPU time’
instance=‘*’/>

</product>

The structure of the XML file may be based upon products. There should only be one management module used for one product, i.e. a product can contain more than one version as above for Microsoft SQL Server 6.5 and 7. Only one of them can be used on a computer. For a product there can be many different parts of a management module to be used since the systems administrator may not have installed all components in a product. The management of a component is located in a file so it does not have to be used but on the other hand also could be used in instances. For example, a database may have many different databases and then it is important that all instances are monitored. This functionality also gives an inventory of the machine. We could find old versions of products still running which may be a security leak and also in that sense that a product that is running but not used requires resources of the computer. An automatic recognition means that the system administrator just have to disable monitoring of products from the console after the installation instead of put a lot of effort in to install the correct components which is very often time-consuming.

Another part of the deployment of monitoring agents that is also time-consuming is the actual move of the kit to the target machine. Instead of installing we clone one real-time engine installation to other nodes. Not to be too hard the required environment must be easy enough to move and the number of files kept down to a minimum. On a Microsoft Windows machine you could create and move the directory tree and remove unwanted files, i.e. files for the specific environment, create a pointer to the directory tree and create the service that runs the real-time engine. When a real-time engine starts and detects that there is no local configuration done it orders that. The utility program may run the recognition phase and restart the real-time engine. This may only require that the system administrator issues this operation and gives the computers on which to deploy. This operation could be done automatically since all nodes are detected and presented to the system administrator but then it could look like a virus. The major issue is to be able to deploy in a fast manner not to waste any time when trying to save time.

Localization is a major issue today that probably can be one of the major issues why Microsoft Windows Operating Systems have been so popular. The most common way to do localizations is to have access to some source code or in some other way has an in depth knowledge of the internals of the program. The method generates files from the encrypted management modules and in those files the descriptive names and other issues can be described in XML-based description. The only requirement is that the localization is performed on a machine using the target language and that the person doing the localization knows the language the original management module is written in.

The execution of generation is built in a program that can read the encrypted management modules. This utility program takes the file of the management module as input and creates an output file in clear text with all the XML tag needed to translate the file. All descriptions and other identifiers that are need may be written in the file. No rules, actions or thresholds, i.e. the knowledge and logics in the management modules are revealed in the file where the translation takes place. Identifiers that can be automatically translated, e.g. identifiers in the Windows Performance Monitor can be translated automatically.

The symbol of the managed object identifiers may be used as the tag in the XML for the translation. Given the example above the translation file may look like:
<P_param1>translated descriptor</P_param1>
   When the real-time engine starts to read all the management files it may check for each file if there is a file with the same name, with only the language code appended. If such a file is present, the real-time engine may check if the current symbol has an element in the language file. If so, the descriptors and other elements from the language file are used instead of the ones from the original management file. Rules, actions and thresholds may of course be used from the original management module.

All these management modules and their language files may be read into a database to make a user decide what language to use independent of which language the computer and product supports. For each object identifier for a managed object this may be stored in the database including the different language codes given by the language files. The management files must state the language code they are written in to make sure that the default language given in the management module can be given a language code. When a user so requires a console could get the string values of all descriptors from the database in accordance with the preferred language code set by the user.

While the present invention has been described in accordance with preferred compositions and embodiments, it is to be understood that certain substitutions and alterations may be made thereto without departing from the spirit and scope of the following claims.

1. A method of monitoring an information system, comprising:
providing a real-time engine unit (12) in communication with a broker unit (14), the engine unit (12) having an event source unit (30) and a metrics source unit (32);
the event source unit (30) monitoring an event unit (42);
the engine unit (12) receiving an event signal (94) from the source unit (30) in a first protocol language;
linking a metrics parameter (48) of the unit (32) to events in the event unit (42) of the event source unit (30);
the metrics parameter (48) counting a number of event occurrences of the event unit (42);
the metrics parameter (48) comparing the number of event occurrences to a threshold value;
the metrics parameter (48) sending an alert signal (96) when the number of event occurrences is greater than the threshold value;
the engine unit (12) receiving the alert signal (96) from the source unit (32) in a second protocol language;
the engine unit (12) converting the first protocol language of the signal (94) and the second protocol language of the signal (96) to a third protocol language;
the engine unit (12) transmitting a signal (74) in the third protocol language, the signal (74) containing information from the signals (94, 96);
the broker unit (14) receiving information of the signal (74) in the third protocol language, the unit (14) converting the information in the third protocol language to a universal protocol language that is understood by a plurality of consumers (16a-16f);
the broker unit (14) sending signals (78a-78f) containing the information in the universal protocol language to the consumer units (16a-16f), respectively; and
the consumer units (16a-16f) receiving the signals (78a-78f) and displaying, in real-time, the metrics parameter (48) linked to the events in the event unit (32).

2. The method according to claim 1 wherein the method further comprises the engine unit (12) filtering information and correlating events.

3. The method according to claim 1 wherein the method further comprises the engine unit (12) is only able to communicate with the broker unit (14).

4. The method according to claim 1 wherein the method further comprises the broker unit (14) converting information from the engine unit (12) to a format that is readable by all the consumers (16a-16f).

5. The method according to claim 1 wherein the method further comprises the broker unit (14) communicating with the engine unit (12) in a unique language (73) that is only used in communication with the broker unit (14) and the engine unit (12).

6. The method according to claim 1 wherein the method further comprises the broker unit (14) converting information in a signal (74) to a uniform protocol (76) that is understood by all the consumers (16a-16f).

7. The method according to claim 1 wherein the method further comprises the source unit (30) monitoring events (42) without retrieving the events (42).

8. The method according to claim 7 wherein the method further comprises grading the event (42) according to a severity grade.

9. The method according to claim 1 wherein the method further comprises the event (42) triggering a second event.

10. The method according to claim 1 wherein the method further comprises the metric source unit (32) monitoring metric parameters.
